(19) United States
(12) Patent Application Publication
(10) Pub. No.: US 2008/0151164 A1
(43) Pub. Date: Jun. 26, 2008

(54) LAMINATE, LIQUID CRYSTAL PANEL, AND LIQUID CRYSTAL DISPLAY APPARATUS

(75) Inventors: Hiroyuki TAKEMOTO, Osaka (JP); Masatoshi TOMONAGA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/964,275

(22) Filed: Dec. 26, 2007

(30) Foreign Application Priority Data
Dec. 25, 2006 (JP) 2006-347713

(51) Int. Cl. G02F 1/13363; G02B 5/30

(52) U.S. Cl. 349/118; 428/1.31; 359/500

(57) ABSTRACT

A laminate according to an embodiment of the present invention includes: a base material; and a birefringence layer formed on the base material and satisfying a relationship of nz>nx=ny, wherein the birefringence layer contains an acrylate polymer.

This application claims priority under 35 U.S.C. Section 119 to Japanese Patent Application No. 2006-347713 filed on Dec. 25, 2006, which is herein incorporated by reference.

### BACKGROUND OF THE INVENTION

1. Field of the Invention

The present invention relates to a laminate having a thin birefringence layer with a very small variation in thickness, a liquid crystal panel and a liquid crystal display apparatus using the laminate.

2. Description of Related Art

Typical examples of a drive mode in a liquid crystal display apparatus provided with a liquid crystal layer (liquid crystal cell) containing liquid crystal molecules that are aligned homogeneously in the absence of an electric field include an in-plane switching (IPS) mode, a fringe field switching (FFS) mode, and a ferroelectric liquid crystal (FLC) mode. For example, the liquid crystal display apparatus provided with a liquid crystal cell of in-plane switching (IPS) mode involves control of light transmittance (white display) and light shielding (black display) through applying an electric field in a lateral direction on liquid crystal molecules aligned in a substantially horizontal direction without application of the electric field to rotate the liquid crystal molecules by about 45°. The conventional liquid crystal display apparatus provided with a liquid crystal cell of IPS mode has problems in that: a contrast ratio is reduced when a screen is viewed from an oblique direction at an angle of 45° (azimuth angle of 45°, 135°, 225°, or 315°) with respect to an absorption axis of a polarizing plate; and a display color varying phenomenon (also referred to as color shift) increases depending on an angle the screen is viewed from. In order to solve the problems involved in a contrast ratio in an oblique direction and a color shift amount in the oblique direction, the use of a laminate having a birefringence layer that satisfies a relationship of nz>nx=ny has been proposed (see JP 2006-178401 A).

However, when the birefringence layer satisfying the relationship of nz>nx=ny is formed by a formation method involving an application process, there occurs a variation in thickness of the birefringence layer due to the variation in application thickness of coating layer, and consequently, there arises a problem in that display roughness occurs in a black display when viewed in an oblique direction.

### SUMMARY OF THE INVENTION

The present invention has been made in view of solving the above-mentioned problems, and an object of the present invention is to provide a laminate having a birefringence layer that satisfies a relationship of nz>nx=ny and has a reduced variation in thickness.

A laminate according to an embodiment of the present invention includes: a base material; and a birefringence layer formed on the base material and satisfying a relationship of nz>nx=ny, wherein the birefringence layer contains an acrylate polymer.

In one embodiment of the invention, the acrylate polymer includes a copolymer of butyl acrylate and ethyl acrylate.

In another embodiment of the invention, a weight average molecular weight of the acrylate polymer is 5,000 to 30,000.

In still another embodiment of the invention, a content of the acrylate polymer in the birefringence layer is 0.1 to 10 parts by weight with respect to 100 parts by weight of a total of materials forming the birefringence layer.

In still another embodiment of the invention, a water contact angle of the opposite side of the birefringence layer with respect to the base material is 20° to 55°.

In still another embodiment of the invention, a haze value of the birefringence layer is 0 to 1.0%.

In still another embodiment of the invention, the base material contains a thermoplastic resin as a main component.

Instill another embodiment of the invention, the thermoplastic resin includes a cycloolefin-based resin.

In still another embodiment of the invention, the base material satisfies a relationship of nx>ny=nz.

In still another embodiment of the invention, the laminate further includes a polarizer.

In still another embodiment of the invention, the base material functions as a protective layer of the polarizer.

In still another embodiment of the invention, the base material is a release film.

According to another aspect of the invention, a liquid crystal panel is provided. The liquid crystal panel includes the above-described laminate and a liquid crystal cell.

According to still another aspect of the invention, a liquid crystal panel is provided. The liquid crystal panel includes a birefringence layer satisfying a relationship of nz>nx=ny transferred from the above-described laminate and a liquid crystal cell.

In one embodiment of the invention, the liquid crystal cell includes a liquid crystal layer containing liquid crystal molecules aligned homogeneously in the absence of an electric field.

In another embodiment of the invention, the liquid crystal cell is one of an IPS mode, an FFS mode, and an FLC mode.

According to still another aspect of the invention, a liquid crystal display apparatus is provided. The liquid crystal display apparatus includes the above-described liquid crystal panel.

The laminate of the present invention includes a base material and a birefringence layer that satisfies a relationship of nz>nx=ny formed on the base material, and the birefringence layer includes a particular leveling agent, i.e., an acrylate polymer. This exhibits an effect that a variation in thickness of the birefringence layer is reduced remarkably.

### BRIEF DESCRIPTION OF THE DRAWINGS

In the accompanying drawings:

FIGS. 1A, 1B, and 1C are schematic cross-sectional views of laminates according to preferred embodiments of the present invention; and

FIG. 2 is a schematic cross-sectional view of a liquid crystal panel according to a preferred embodiment of the present invention.

### DETAILED DESCRIPTION OF THE PREFERRED EMBODIMENTS

### Definitions of Terms and Symbols

The definitions of terms and symbols used in this specification are as follows.

(1) “nx” refers to a refractive index in a direction in which an in-plane refractive index becomes maximum (i.e., a slow axis direction), “ny” refers to a refractive index in a direction perpendicular to a slow axis in the same plane (i.e., a fast axis direction), and “nz” refers to a refractive index in a thickness direction. Further, for example, “nx=ny” also includes the case where nx and ny are substantially equal to each other, as well as the case where nx and ny are strictly equal to each other. In the specification of the present invention, “substantially equal” is intended to include the case where nx and ny are different in a range not practically influencing the entire polarization properties of a laminate. Similarly, “ny=nz” also includes the case where ny and nz are substantially equal to each other, as well as the case where ny and nz are strictly equal to each other.

(2) The term “in-plane retardation Re” refers to a retardation value in a film (layer) plane measured with light having a wavelength of 590 nm at 23° C. Re is obtained by an expression: Re=(nx−ny)×d, where nx is a refractive index in a slow axis direction of a film (layer) and ny is a refractive index in a fast axis direction thereof at a wavelength of 590 nm, and d (nm) is the thickness of a film (layer).

(3) A thickness direction retardation Rth refers to a retardation value in a thickness direction measured with light having a wavelength of 590 nm at 23° C. Rth is obtained by an expression: Rth=(nx−nz)×d, where nx is a refractive index in a slow axis direction of a film (layer), nz is a refractive index in a thickness direction thereof at a wavelength of 590 nm, and d (nm) is the thickness of a film (layer).

### A. Entire Configuration of a Laminate

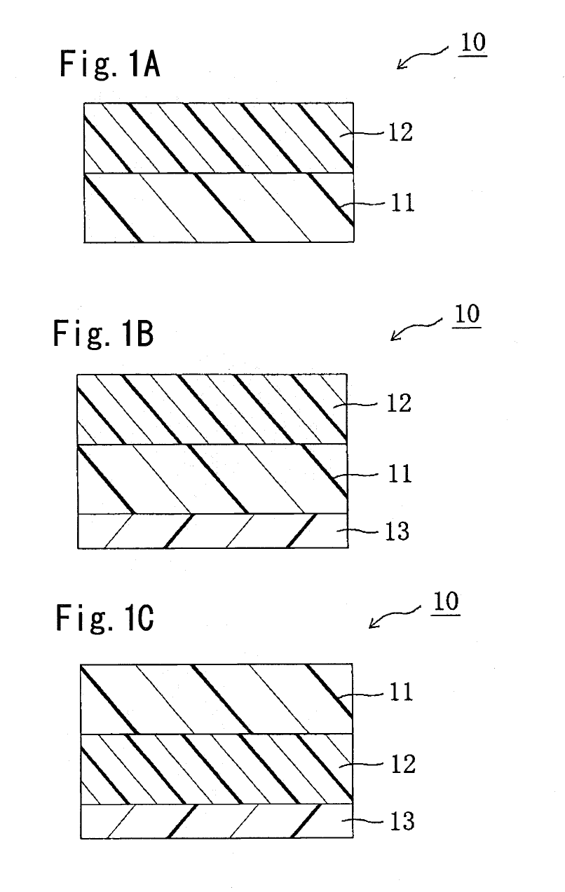

FIG. 1A is a schematic cross-sectional view of a laminate according to a preferred embodiment of the present invention. As shown in FIG. 1A, a laminate 10 of the present invention includes a base material 11 and a birefringence layer 12 formed on the base material 11.

FIG. 1B is a schematic cross-sectional view of a laminate according to another preferred embodiment of the present invention. As shown in FIG. 1B, the laminate 10 of the present invention can further include a polarizer 13 on an opposite side of the base material 11 with respect to the birefringence layer 12, if required.

FIG. 1C is a schematic cross-sectional view of a laminate according to still another preferred embodiment of the present invention. As shown in FIG. 1C, the laminate 10 of the present invention can further include the polarizer 13 on an opposite side of the birefringence layer 12 with respect to the base material 11, if required.

In the embodiment in which the laminate 10 has the polarizer 13, if required, any suitable protective layer (not shown) may be provided on at least one surface of the polarizer 13. Each of the layers constituting the laminate 10 is placed via any suitable pressure-sensitive adhesive layer or adhesive layer (not shown)

### B. Birefringence Layer

The birefringence layer is a so-called positive C-plate satisfying a relationship of nz>nx=ny. The birefringence layer includes an acrylate polymer.

As described above, in the specification of the present invention, “nx=ny” includes not only the case where nx and ny are strictly equal to each other, but also the case where they are substantially equal to each other. Therefore, the birefringence layer can have an in-plane retardation, and can further have a slow axis. In this case, an in-plane retardation Re of the birefringence layer is preferably 0 to 10 nm, more preferably 0 to 7 nm, and still more preferably 0 to 5 nm. By setting the in-plane retardation Re in the above range, a contrast ratio in an oblique direction of a liquid crystal display apparatus can be enhanced in the case where the laminate of the present invention is used in the liquid crystal display apparatus.

The thickness direction retardation Rth of the birefringence layer is preferably −200 to −30 nm, more preferably −180 to −50 nm, and still more preferably −170 to −70 nm. By setting the thickness direction retardation Rth in the above range, a contrast ratio in an oblique direction of the liquid crystal display apparatus can be enhanced in the case where the laminate of the present invention is used in the liquid crystal display apparatus.

As the birefringence layer, a layer which is excellent in transparency, mechanical strength, heat stability, a moisture shielding property, and the like, and which is unlikely to cause optical unevenness due to distortion is preferably used. Such a birefringence layer is preferably a solidified layer or a cured layer of a liquid crystalline composition aligned in homeotropic alignment.

In the specification of the present invention, “homeotropic alignment” refers to a state in which a liquid crystal compound contained in a liquid crystalline composition is aligned uniformly in parallel to a normal direction of a film. Further, the term “solidified layer” refers to a layer which is prepared by cooling a softened or molten liquid crystalline composition or a liquid crystalline composition in a solution state into a solidified state. The term “cured layer” refers to a layer which is prepared by cross-linking the liquid crystalline composition by heat, a catalyst, light, and/or radiation into a stable insoluble and infusible state or a stable hardly soluble and hardly fusible state. Note that the “cured layer” includes a cured layer prepared from a solidified layer of a liquid crystalline composition.

In the specification of the present invention, the term “liquid crystalline composition” refers to a composition having a liquid crystal phase and exhibiting liquid crystallinity. Examples of the liquid crystal phase include a nematic liquid crystal phase, a smectic liquid crystal phase, and a cholesteric liquid crystal phase. The liquid crystalline composition to be used in the present invention is preferably a liquid crystalline composition exhibiting a nematic liquid crystal phase for attaining a retardation film having high transparency.

The liquid crystalline composition includes a liquid crystal compound and an acrylate polymer. Owing to including the acrylate polymer, the birefringence layer can be significantly reduced in thickness unevenness caused by application unevenness. As a result, display roughness in a liquid crystal display apparatus employing the laminate of the present invention can be remarkably reduced when the black display is viewed in the oblique direction.

Examples of the mesogenic group containing a cyclic unit or the like of the liquid crystal compound include a biphenyl group, a phenylbenzoate group, a phenylcyclohexane group, an azoxybenzene group, an azomethine group, an azobenzene group, a phenyl pyrimidine group, a diphenylacetylene group, a diphenylbenzoate group, a bicyclohexane group, a cyclohexylbenzene group, and a terphenyl group. A terminal of the cyclic unit may have a substituent such as a cyano group, an alkyl group, an alkoxy group, or a halogen group. Of those, a mesogenic group containing a cyclic unit or the like to be used preferably has a biphenyl group or a phenylbenzoate group.

The liquid crystal compound to be used preferably has at least one polymerizable functional group in a part of a molecule. Examples of the polymerizable functional group include an acryloyl group, a methacryloyl group, an epoxy group, and a vinyl ether group. Of those, an acryoloyl group or a methacryloyl group is preferably used. Further, the liquid crystal compound preferably has two or more polymerizable functional groups in a part of a molecule, to thereby improve durability by a crosslinked structure formed through a polymerization reaction. A specific example of a liquid crystal compound having two polymerizable functional groups in a part of a molecule includes “Paliocolor LC242” (trade name, available from BASF Aktiengesellschaft).

Further, a birefringence layer used for the positive C plate is more preferably a solidified layer or a cured layer obtained by homeotropically aligning a liquid crystalline composition containing a liquid crystal compound described in JP 2002-174725 A. Particularly preferred is a solidified layer or a cured layer obtained by homeotropically aligning a liquid crystalline composition containing a liquid crystal polymer represented by the following General Formula (1) as a liquid crystal compound. Most preferred is a cured layer obtained by homeotropically aligning a liquid crystalline composition containing a liquid crystal polymer represented by the following General Formula (1) and a liquid crystal compound having at least one polymerizable functional group in a part of a molecule. With such a liquid crystalline composition, a birefringence layer having excellent optical uniformity and high transparency can be obtained.

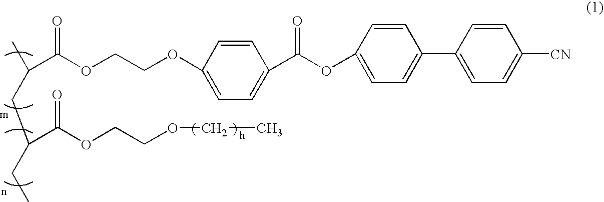

In the formula, h represents an integer of 14 to 20, and assuming that the sum of m and n is 100, m represents 50 to 70 and n represents 30 to 50.

The content of a liquid crystal compound in the liquid crystalline composition is preferably 40 to 99.9 parts by weight, more preferably 50 to 99.5 parts by weight, and still more preferably 60 to 99 parts by weight with respect to 100 parts by weight of a total solid (total of materials forming the birefringence layer).

As the acrylate polymer, any suitable polymer can be used within a range not inhibiting the object of the present invention.

As a monomer unit for constituting the acrylate polymer, any suitable acrylate may be used as long as it does not inhibit the object of the present invention. Specific examples of the acrylate include: alkyl acrylates such as methyl acrylate, ethyl acrylate, propylacrylate, isopropylacrylate, butylacrylate, pentylacrylate, and hexyl acrylate; and cycloalkyl acrylates such as cyclopentanyl acrylate and cyclohexyl acrylate. Of those, methyl acrylate, ethyl acrylate, propyl acrylate, isopropyl acrylate, butyl acrylate, pentyl acrylate, or hexyl acrylate may be preferably used.

The monomer unit may be used alone or in combination. Preferably, a combination of at least two kinds of monomer units is used. In this case, examples of a preferred combination of monomer units include a combination of at least two kinds of acrylates selected from the group consisting of methyl acrylate, ethyl acrylate, propyl acrylate, isopropyl acrylate, butyl acrylate, pentyl acrylate, and hexyl acrylate, and a more preferred example thereof includes a combination of butyl acrylate and ethyl acrylate. Of those, an acrylate polymer containing butyl acrylate and ethyl acrylate in a molar ratio of preferably 70:30 to 30:70 (butyl acrylate:ethyl acrylate), more preferably 65:35 to 35:65, and still more preferably 60:40 to 40:60 can be preferably used.

The acrylate polymer can contain any suitable monomer unit other than acrylate within a range not inhibiting the object of the present invention.

In the case where at least two kinds of monomer units are used, the acrylate polymer may have a random structure or a block structure. Preferably, the acrylate polymer is a block polymer.

The weight average molecular weight Mw of the acrylate polymer measured by a gel permeation chromatograph method (GPC apparatus: “HLC-8120GPC” (trade name) manufactured by Tosoh Corporation, column: GMH_{XL}/GMH_{XL}/G3000H_{XL}) using a tetrahydrofuran as an eluant is preferably 5,000 to 30,000, more preferably 6,000 to 25,000, and still more preferably 8,000 to 20,000.

The content of the acrylate polymer in the liquid crystalline composition is preferably 0.1 to 10 parts by weight, more preferably 0.3 to 5 parts by weight, and still more preferably 0.5 to 3 parts by weight with respect to 100 parts by weight of a total solid content (total of materials forming the birefringence layer).

Further, the liquid crystalline composition may contain various kinds of additives such as a polymerization initiator, an aligning agent, a heat stabilizer, a lubricant, a plasticizer, and an antistatic agent within a range not inhibiting the object of the present invention.

The liquid crystalline composition is aligned homeotropically on a base material, and solidified or cured in that state, whereby the alignment of the liquid crystal compound is fixed. Consequently, a solidified layer or a cured layer of a liquid crystalline composition can be formed as the birefringence layer having the above-mentioned optical properties.

As a method of obtaining a liquid crystalline composition aligned homeotropically, there is a method, for example, of applying a melted material or a solution of the liquid crystalline composition to a base material subjected to alignment treatment (described later) Preferably, there is a method of applying a solution (which may also be referred to as application solution) obtained by dissolving the liquid crystalline composition in any suitable solvent to a base material subjected to alignment treatment. According to the above method, a birefringence layer with less alignment defects (which may also be referred to as discrination) of a liquid crystalline composition can be obtained.

The concentration of a total solid content of the application solution varies depending upon solubility, application viscosity, wettability with respect to a base material, the thickness after application, and the like. Regarding the concentration, in general, a solid content is 2 to 100 parts by weight, preferably 3 to 50 parts by weight, and more preferably 5 to 40 parts by weight with respect to 100 parts by weight of a solvent. If the concentration is in the above range, a birefringence layer with high surface uniformity can be obtained.

As the solvent, a liquid material capable of dissolving a liquid crystalline composition uniformly to form a solution is preferably used. The solvent may be a nonpolar solvent such as benzene or hexane, or a polar solvent such as water or alcohol. Further, the solvent may be an inorganic solvent such as water, or an organic solvent such as alcohols, ketones, ethers, esters, aliphatic and aromatic hydrocarbons, halogenated hydrocarbons, amides, or cellosolves. The solvent is preferably at least one kind of solvent selected from cyclopentanone, cyclohexanone, methylisobutylketone, methylethylketone, toluene, ethyl acetate, and tetrahydrofuran. Those solvents are preferred because they can dissolve the above composition sufficiently without causing corrosion that practically has an adverse effect on a base material.

As a method of applying the application solution to a base material, an application method using any suitable coater can be used. Specifically, for example, a bar coater, a reverse roll coater, a forward rotation roll coater, a gravure coater, a knife coater, a rod coater, a slot orifice coater, a curtain coater, a fountain coater, an air doctor coater, a kisscoater, a dip coater, a bead coater, a blade coater, a cast coater, a spray coater, a spin coater, an extrusion coater, or a hot-melt coater can be used.

The thickness of application of the application solution can be selected appropriately depending upon the thickness desired for a birefringence layer and the like. The thickness is generally 0.1 μm to 10 μm, preferably 0.3 μm to 5 μm, and more preferably 0.5 μm to 3 μm.

As a method of fixing a liquid crystalline composition aligned homeotropically, any of a solidifying method and/or a curing method can be adopted depending upon the kind of a liquid crystal compound to be used. For example, in the case where a liquid crystalline composition contains a liquid crystal polymer as a liquid crystal compound, practically sufficient mechanical strength can be obtained by solidifying a melted material or a solution containing the liquid crystal polymer. On the other hand, in the case where a liquid crystalline composition contains a liquid crystal monomer as a liquid crystal compound, mechanical strength may not be obtained sufficiently merely by solidifying a solution of the liquid crystal monomer. In such a case, for example, by using a polymerizable liquid crystal monomer having at least one polymerizable functional group in a part of a molecule, and curing the polymerizable liquid crystal monomer by irradiation with a UV-ray, practically sufficient mechanical strength can be obtained. As irradiation conditions of a UV-ray, for example, those which are described in JP 2006-178401 A (paragraphs [0107] to [0112]) can be used.

In the present invention, a base material with an application solution applied thereto may be subjected to a drying treatment before and/or after the irradiation with a UV-ray. The temperature (drying temperature) in the drying treatment is not particularly limited, but is preferably in a range exhibiting a liquid crystal phase of the liquid crystalline composition. Further, the drying temperature is preferably a glass transition temperature (Tg) of a base material or lower. The drying temperature is in a range of preferably 50° C. to 130° C., and more preferably 80° C. to 100° C. In the case where the drying temperature is in the above range, a birefringence layer with high uniformity can be produced.

Although not particularly limited, the time (drying time) for the drying treatment is, for example, 1 to 20 minutes, preferably 1 to 15 minutes, and more preferably 2 to 10 minutes in order to obtain a birefringence layer with satisfactory optical uniformity.

The contact angle for pure water of one side of thus obtained birefringence layer, which is the opposite side with respect to the side facing a base material, is preferably 20° to 55°, more preferably 25° to 53°, and still more preferably 30° to 50°. In the case where the contact angle is in the above range, the wettability of the surface of the birefringence layer increases, and the adhesive property with respect to other optical elements can be enhanced.

If required, the birefringence layer may be subjected to various kinds of surface treatments. Any suitable method can be adopted as the surface treatment in accordance with the purpose. Examples of the method include a low-pressure plasma treatment, a UV-ray irradiation treatment, a corona treatment, a flame treatment, and an acid or alkali treatment. By performing a suitable surface treatment, the water contact angle can be controlled to be in a desired range.

The transmittance of the birefringence layer measured with light having a wavelength of 590 nm at 23° C. is preferably 80% or more, more preferably 85% or more, and still more preferably 90% or more.

The haze value of the birefringence layer is preferably 0 to 1.0%, more preferably 0 to 0.8%, and still more preferably 0 to 0.5%. In the case where the haze value is in the above range, a birefringence layer having excellent transparency can be obtained.

The birefringence index (nx−nz) in a thickness direction of the birefringence layer measured with light having a wavelength of 589 nm at 23° C. is preferably −0.2 to −0.03, more preferably −0.15 to −0.05, and still more preferably −0.13 to −0.07. In the case where the birefringence is in the above range, a thin birefringence layer with a small variation in an in-plane retardation value can be obtained.

The thickness of the birefringence layer can be selected appropriately depending upon the purpose. Specifically, the thickness is preferably 0.1 μm to 10 μm, more preferably 0.3 μm to 5 μm, and still more preferably 0.5 μm to 3 μm. In the case where the thickness is in the above range, a birefringence layer having excellent mechanical strength and display uniformity can be obtained.

### C. Base Material

Any suitable base material can be used as long as it is capable of supporting the birefringence layer. Specifically, for example, polymer base materials such as a film and a plastic substrate are preferably used. This is because such a polymer base material is excellent in smoothness of the surface of a base material and wettability of a liquid crystalline composition, and is capable of being applied to a continuous production with a roll to enhance the productivity greatly.

The base material is typically a stretched film (retardation film) of a polymer film containing a thermoplastic resin as a main component. Examples of the thermoplastic resin include general-purpose plastic such as polyethylene, polypropylene, polynorbornene, polyvinyl chloride, cellulose ester, polystyrene, ABS resin, AS resin, methyl polymethacrylate, polyvinyl acetate, and polyvinylidene chloride; general-purpose engineering plastic such as polyamide, polyacetal, polycarbonate, denatured polyphenylene ether, polybutyleneterephthalate, and polyethyleneterephthalate; and super-engineering plastic such as polyphenylene sulfide, polysulfon, polyethersulfon, polyether ether ketone, polyarylate, liquid crystal polymer, polyamideimide, polyimide, and polytetrafluoroethylene. The thermoplastic resin may be used alone or in combination. Preferably, the thermoplastic resin is a cycloolefin-based resin such as polynorbornene, or a polycarbonate for the reasons that they are excellent in transparency, mechanical strength, heat stability, a moisture shielding property, and the like, and are excellent in the ability of exhibiting a retardation value, the easiness of control of a retardation value, the adhesive property with respect to a polarizer, and the like. Thus, a base material containing the preferred thermoplastic resin as a main component can be used directly in a liquid crystal panel without being peeled from the birefringence layer (positive C plate) In this case, the base material can function as a retardation film or a protective layer of a polarizer, for example.

The polynorbornene refers to a (co)polymer obtained by using a norbornene-based monomer having a norbornene ring in a part or an entirety of a starting material (monomer). Examples of the norbornene-based monomer include norbornene, and alkyl and/or alkylidene substituent thereof (e.g., 5-methyl-2-norbornene, 5-dimethyl-2-norbornene, 5-ethyl-2-norbornene, 5-butyl-2-norbornene, and 5-ethylidene-2-norbornene), and a substituent thereof with a polar group such as halogen; dicyclopentadiene, 2,3-dihydrodicyclopentadiene, etc.; and dimethanooctahydronaphthalene, alkyl and/or alkylidene substituent thereof, and a substituent thereof with a polar group such as halogen, a trimer and tetramer of cyclopentadiene (e.g., 4,9:5,8-dimethano-3a,4,4a,5,8,8a,9,9a-octahydro-1H-benzoindene, 4,11:5,10:6,9-trimethano-3a,4,4a,5,5a,6,9,9a,10,10a,11,11a-dod ecahydro-1H-cyclopentaanthracene).

Regarding the weight average molecular weight (Mw) of the polynorbornene, a value determined by a gel permeation chromatograph (GPC) method with a toluene solvent is preferably 20,000 to 400,000, more preferably 30,000 to 300,000, particularly preferably 40,000 to 200,000, and most preferably 40,000 to 80,000. In the case where the weight average molecular weight is in the above range, a resin being excellent in mechanical strength and having satisfactory solubility, forming property, and casting workability can be obtained.

Regarding the polynorbornene, various products are commercially available. Specific examples thereof include “ZEONEX” (trade name) and “ZEONOR” (trade name) manufactured by Zeon Corporation, “Arton” (trade name) manufactured by JSR Corporation, “TOPAS” (trade name) manufactured by Ticona GmbH, and “APEL” (trade name) manufactured by Mitsui Chemicals Inc.

As the polycarbonate, an aromatic polycarbonate containing an aromatic bivalent phenol component and a carbonate component is preferably used. The aromatic polycarbonate may be generally obtained through a reaction of an aromatic bivalent phenol compound and a carbonate precursor. That is, the aromatic polycarbonate may be obtained through: a phosgen method involving blowing phosgen into an aromatic bivalent phenol compound in the presence of caustic alkali and a solvent; or an ester exchange method involving performing ester exchange between an aromatic bivalent phenol compound and bisaryl carbonate in the presence of a catalyst.

Specific examples of the aromatic bivalent phenol compound include: 2,2-bis(4-hydroxyphenyl)propane; 9,9-bis(4-hydroxyphenyl)fluorene; 4,4′-biphenol; 4,4′-dihydroxybiphenylether, 2,2-bis(3-methyl-4-hydroxyphenyl)propane; 2,2-bis(3-bromo-4-hydroxyphenyl)propane; 2,2-bis(4-hydroxy-3,5-dimethylphenyl)propane; bis(4-hydroxyphenyl)methane; 1,1-bis(4-hydroxyphenyl)ethane; 2,2-bis(4-hydroxyphenyl)butane; 2,2-bis(4-hydroxy-3,5-dimethylphenyl)butane; 2,2-bis(4-hydroxy-3,5-dipropylphenyl)propane; 1,1-bis(4-hydroxyphenyl)cyclohexane; and 1,1-bis(4-hydroxyphenyl)-3,3,5-trimethylcyclohexane. They may be used alone or in combination.

Examples of the carbonate precursor include phosgene, bischloroformates of the above bivalent phenols, diphenyl carbonate, di-p-tolylcarbonate, phenyl-p-tolylcarbonate, di-p-chlorophenyl carbonate, and dinaphthyl carbonate. Of those, phosgene and diphenyl carbonate are preferred.

The polycarbonate has a weight average molecular weight (Mw) of preferably 25,000 to 250,000, more preferably 30,000 to 200,000, and particularly preferably 40,000 to 100,000 determined by gel permeation chromatography (GPC) method with a tetrahydrofuran solvent. In the case where the weight average molecular weight is in the above range, a resin being excellent in mechanical strength and having satisfactory solubility, forming property, and casting workability can be obtained.

The base material may further contain any appropriate additive, if required. Specific examples of the additive include a plasticizer, a thermal stabilizer, alight stabilizer, a lubricant, an antioxidant, a UV absorber, a flame retardant, a colorant, an antistatic agent, a compatibilizing agent, a cross-linking agent, and a thickener. The kind and amount of the additive to be used may be appropriately set depending on the purpose. An amount of the additive used is, typically, 0.1 to 10 parts by weight with respect to 100 parts by weight of a total solid of a base material.

Any appropriate forming method may be employed as a method of obtaining the base material. Any appropriate method may be selected from, for example, compression molding, transfer molding, injection molding, extrusion molding, blow molding, powder molding, FRP molding, solvent casting, and the like. Of those, extrusion molding or solvent casting is preferably employed. This is because the smoothness of a base material film to be obtained is enhanced, whereby satisfactory optical uniformity can be obtained. The forming conditions can be set appropriately depending upon the composition, kind, and the like of a resin to be used. Regarding the cycloolefin-based resin (for example, polynorbornene), a number of film products are commercially available, and they can be used as they are.

The thickness of the base material is, for example, 5 μm to 500 μm, preferably 10 μm to 200 μm, and more preferably 15 μm to 150 μm.

The base material is subjected to an alignment treatment so as to form the birefringence layer. Any appropriate alignment treatment may be selected in accordance with the kind of liquid crystal compound, the material for the base material, and the like. Specific examples thereof include: base material surface direct alignment treatment (A); base material surface indirect alignment treatment (B); and base material surface deformation alignment treatment (C). In the specification of the present invention, the term “base material surface direct alignment treatment (A)” refers to a method involving: forming a thin layer of an aligning agent on a base material surface through a method such as solution application (wet treatment), or plasma polymerization or sputtering (dry treatment); and adjusting an alignment direction of a liquid crystal compound in a specific direction by utilizing interaction between the aligning agent and the liquid crystal compound. The term “base material surface indirect alignment treatment (B)” refers to a method involving: applying a liquid crystalline composition having an aligning agent dissolved in advance on a base material surface; and adjusting an alignment direction of a liquid crystal compound in a specific direction by utilizing a phenomenon of the aligning agent permeating from the liquid crystalline composition and adsorbing on the base material surface and by utilizing interaction between the aligning agent and the liquid crystal compound. The term “base material surface deformation alignment treatment (C)” refers to a method involving: deforming a base material surface for forming a rough surface; and adjusting an alignment direction of a liquid crystal compound in a specific direction by utilizing interaction between the rough surface and the liquid crystal compound. Of those, the base material surface direct alignment treatment (A) is preferably used in the present invention because this treatment has excellent aligning ability of the liquid crystal compound, to thereby provide a highly transparent birefringence layer with excellent optical uniformity.

Specific examples of the aligning agent subjected to solution application on the base material surface include lecithin, stearic acid, hexadecyltrimethylammonium bromide, octadecylamine hydrochloride, a monobasic chromium carboxylate complex (such as a chromium myristate complex or a chromium perfluorononanoate complex), and an organic silane (such as a silane coupling agent or siloxane). Specific examples of the aligning agent subjected to plasma polymerization on the base material surface include perfluorodimethylcyclohexane and tetrafluoroethylene. A specific example of the aligning agent subjected to sputtering on the base material surface is polytetrafluoroethylene. Of those, an organic silane is particularly preferably used as the aligning agent because of its excellent workability, product quality, and aligning ability of the liquid crystal compound. A specific example of the organic silane as the aligning agent is “Ethyl silicate” (trade name, available from COLCOAT Co., Ltd.) containing tetraethoxysilane as a main component.

As a method of preparing the aligning agent, a commercially available aligning agent or a commercially available solution or dispersion containing an aligning agent may be used instead of the above, a solvent may be further added to the commercially available aligning agent or a commercially available solution or dispersion containing an aligning agent, or a solid content may be dissolved or dispersed in various solvents.

In one embodiment, the base material can be a so-called positive A plate that satisfies a relationship of nx>ny=nz. In the case where the base material is a positive A plate, the use of the base material together with the birefringence layer having the above optical properties can enhance a contrast ratio in an oblique direction of a liquid crystal display apparatus and greatly contribute to the reduction in thickness of a liquid crystal panel.

An in-plane retardation Re of the base material that is a positive A plate is preferably 60 to 200 nm, more preferably 80 to 180 nm, and still more preferably 100 to 150 nm.

In the specification of the present invention, “ny=nz” includes not only the case where ny and nz are strictly equal to each other, but also the case where ny and nz are substantially equal to each other. Therefore, the Nz coefficient of the base material that is a positive A plate can be a value other than 1. The Nz coefficient is preferably 1 to 2, more preferably 1 to 1.7, and still more preferably 1 to 1.5. In the case where the Nz coefficient is in the above range, a contrast ratio in an oblique direction of a liquid crystal display apparatus can be enhanced. The Nz coefficient is obtained from the following Expression (2).

Nz=(nx−nz)/(nx−ny) (2)

In the case where the base material is a positive A plate, the thickness thereof can be set so that a desired in-plane retardation Re is obtained. The thickness is preferably 60 μm to 200 μm, more preferably 80 μm to 180 μm, and still more preferably 100 μm to 150 μm.

In the case where the base material is a positive A plate, an in-plane retardation Re thereof can be controlled by stretching, if needed, the polymer film containing the thermoplastic resin as a main component.

As a stretching method, any of a stretching method can be selected depending upon the kind of a resin to be used and the like. For example, a longitudinal uniaxial stretching method, a transverse uniaxial stretching method, a simultaneous biaxial stretching method, and a sequential biaxial stretching method can be adopted.

The stretching ratio can vary appropriately depending upon the in-plane retardation Re and thickness desired for a base material, the kind of a resin to be used, the thickness of a film to be used, a stretching temperature, and the like. For example, in the case where a cycloolefin-based resin is used, the stretching ratio is preferably 1.2 to 6 times, more preferably 1.5 to 5 times, and still more preferably 1.8 to 4 times. By performing stretching at such a stretching ratio, a base material having the above optical properties can be obtained.

The stretching temperature can vary appropriately depending upon the in-plane retardation Re and thickness desired for a base material, the kind of a resin to be used, the thickness of a film to be used, a stretching ratio, and the like. For example, in the case where a cycloolefin-based resin is used, the stretching temperature is preferably 120° C. to 180° C., more preferably 130° C. to 170° C., and still more preferably 140° C. to 160° C. By performing stretching at such a stretching temperature, a base material having the above optical properties can be obtained.

In another embodiment, a liquid crystalline composition aligned homeotropically on the base material is solidified or cured, and thereafter, the base material can be peeled from the solidified layer or cured layer (birefringence layer). More specifically, the base material can be a release film.

### D. Polarizer

Any suitable polarizers may be employed as the polarizer depending on the purpose. Examples of the polarizer include: a film prepared by adsorbing a dichromatic substance such as iodine or a dichromatic dye on a hydrophilic polymer film such as a polyvinyl alcohol-based film, a partially formalized polyvinyl alcohol-based film, or an ethylene/vinyl acetate copolymer-based partially saponified film and uniaxially stretching the film; and a polyene-based orientated film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred in view of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also prevents nonuniformity such as uneven coloring or the like by swelling the polyvinyl alcohol-based film. The stretching of the film may be carried out after coloring of the film with iodine, carried out during coloring of the film, or carried out followed by coloring of the film with iodine. The stretching may be carried out in an aqueous solution of boric acid or potassium iodide, or in a water bath.

### E. Protective Layer

The protective layer may employ any appropriate film which can be used as a protective layer of a polarizer. Specific examples of a material to be included as a main component of the film include: a cellulose-based resin such as triacetyl cellulose (TAC); and transparent resins such as a polyester-based resin, a polyvinyl alcohol-based resin, a polycarbonate-based resin, a polyamide-based resin, a polyimide-based resin, a polyethersulfone-based resin, a polysulfone-based resin, a polystyrene-based resin, a polynorbornene-based resin, a polyolefin-based resin, an acrylic resin, and an acetate-based resin. Other examples thereof include: a thermosetting resin and a UV-curable resin, such as an acrylic resin, an urethane-based resin, an acrylurethane-based resin, an epoxy-based resin, and a silicone-based resin. Still another example thereof is a glassy polymer such as a siloxane-based polymer. Further, a polymer film described in JP 2001-343529 A (WO 01/37007) may also be used. A material for the film may employ a resin composition containing a thermoplastic resin having a substituted or unsubstituted imide group on a side chain, and a thermoplastic resin having a substituted or unsubstituted phenyl group and nitrile group on a side chain, for example. A specific example thereof is a resin composition containing an alternating isobutene/N-methylmaleimide copolymer, and an acrylonitrile/styrene copolymer. The polymer film may be an extrusion molded product of the resin composition described above, for example. TAC, a polyimide-based resin, a polyvinyl alcohol-based resin, and a glassy polymer are preferred. TAC is more preferred.

As the thickness of the protective layer, any appropriate thickness can be adopted. Specifically, the thickness of the protective layer is preferably 5 mm or less, more preferably 1 mm or less, still more preferably 1 μm to 500 μm, and particularly preferably 5 μm to 150 μm.

The protective layer is preferably transparent and colorless. In one embodiment, the base material can be used as a protective layer. In this case, it is not necessary to provide a protective layer separately, which can greatly contribute to the reduction in thickness of a liquid crystal panel.

### F. Pressure-Sensitive Adhesive Layer

As a pressure-sensitive adhesive forming a pressure-sensitive adhesive layer, any appropriate pressure-sensitive adhesive can be adopted. Specific examples thereof include a solvent type pressure-sensitive adhesive, a non-aqueous emulsion type pressure-sensitive adhesive, an aqueous pressure-sensitive adhesive, and a hotmelt pressure-sensitive adhesive. Of those, a solvent type pressure-sensitive adhesive containing an acrylic polymer as a base polymer is preferably used.

The thickness of the pressure-sensitive adhesive layer can be appropriately set depending upon the use purpose, the adhesive property, and the like. Specifically, the thickness of the pressure-sensitive adhesive layer is preferably 1 μm to 100 μm, more preferably 5 μm to 50 μm, and still more preferably 10 μm to 30 μm.

### G. Adhesive Layer

As an adhesive forming an adhesive layer, typically, there is a curable adhesive. Typical examples of the curable adhesive include a photo-curable adhesive such as a UV-curable adhesive, a moisture-curable adhesive, and a thermosetting adhesive.

The applying amount of an adhesive between each of the layers can be set appropriately depending upon the purpose. For example, the applying amount is preferably 0.3 to 3 ml, more preferably 0.5 to 2 ml, and still more preferably 1 to 2 ml per area (cm²) with respect to a principal plane of each layer.

After the application, a solvent contained in the adhesive is volatilized by natural drying or heat drying, if required. The thickness of the adhesive layer thus obtained is preferably 0.1 μm to 20 μm, more preferably 0.5 μm to 15 μm, and still more preferably 1 μM to 10 μm.

The pressure-sensitive adhesive or adhesive can be selected appropriately depending upon the kind of an adherend (optical element).

### H. Other Optical Elements

The laminate of the present invention may further include other optical elements. As such other optical elements, any appropriate optical elements can be adopted depending upon the application. Specific examples of the other optical elements include a liquid crystal film, a light scattering film, a diffraction film, and another retardation film.

### I. Liquid Crystal Panel

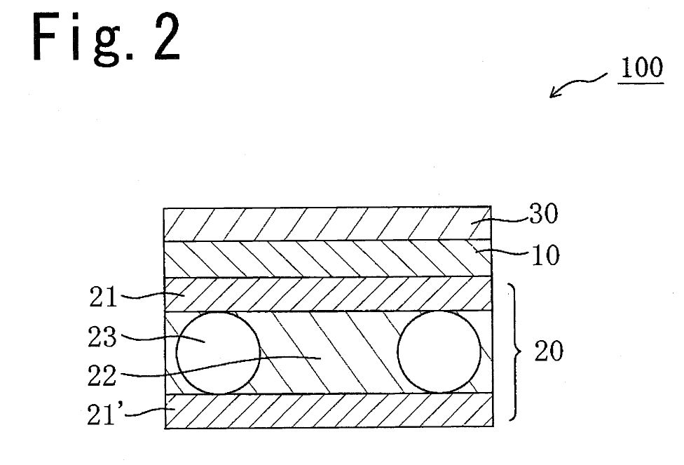

FIG. 2 is a schematic cross-sectional view of a liquid crystal panel according to a preferred embodiment of the present invention. The liquid crystal panel 100 includes a liquid crystal cell 20, a laminate 10 placed on one side of the liquid crystal cell 20, and a polarizer 30 placed on an opposite side of the laminate 10 with respect to the liquid crystal cell 20. The laminate 10 is a laminate of the present invention. In the case where the laminate 10 has a polarizer, the polarizer 30 is omitted. In one embodiment, the above base material is peeled from the laminate 10. Although not shown, practically, a polarizer and any optional optical compensation layer may be placed on the other side of the liquid crystal cell 20.

The liquid crystal panel 100 can be produced by laminating the liquid crystal cell 20 and the laminate 10 via any suitable pressure-sensitive adhesive layer or adhesive layer (not shown). The pressure-sensitive adhesive layer and adhesive layer are as described in the above sections F and G, respectively. Further, in the case where the base material is a release film, a liquid crystal panel including the birefringence layer and a liquid crystal cell can be produced by transferring the birefringence layer from the laminate to the liquid crystal cell.

The liquid crystal cell 20 used in the liquid crystal panel of the present invention is provided with: a pair of substrates 21 and 21′; and a liquid crystal layer 22 as a display medium held between the substrates 21 and 21′. One substrate (color filter substrate) is provided with color filters and black matrix (both not shown). The other substrate (active matrix substrate) is provided with: a switching element (typically TFT) for controlling electrooptic properties of liquid crystals; a scanning line for providing a gate signal to the switching element and a signal line for providing a source signal thereto; and a pixel electrode and a counter electrode (each of them not shown). The color filters may be provided in the active matrix substrate as well. A distance (cell gap) between the substrates 21 and 21′ is controlled by a spacer 23. An alignment film (not shown) formed of, for example, polyimide is provided on a side of each of the substrates 21 and 21′ in contact with the liquid crystal layer 22.

The liquid crystal layer 22 preferably contains homogeneously aligned liquid crystal molecules in the absence of an electric field. The liquid crystal layer (eventually, the liquid crystal cell) generally exhibits a refractive index profile of nx>ny=nz (where, nx, ny, and nz respectively represent refractive indices in the slow axis direction, fast axis direction, and thickness direction of the liquid crystal layer). In the specification of the present invention, ny=nz includes not only a case where ny and nz are exactly equal, but also a case where ny and nz are substantially equal. Further, the phrase “initial alignment direction of the liquid crystal cell” refers to a direction providing a maximum in-plane refractive index of the liquid crystal layer by alignment of the liquid crystal molecules in the liquid crystal layer in the absence of an electric field. Typical examples of drive mode using the liquid crystal layer exhibiting such refractive index profile include: in-plane switching (IPS) mode; fringe field switching (FFS) mode; and ferroelectric liquid crystal (FLC) mode. Specific examples of liquid crystals used for those drive modes include nematic liquid crystals and smectic liquid crystals. For example, the nematic liquid crystals are used for the IPS mode and the FFS mode, and the smectic liquid crystals are used for the FLC mode.

In the IPS mode, homogeneously aligned liquid crystal molecules in the absence of an electric field respond in an electric field parallel to substrates (also referred to as a horizontal electric field) generated between a counter electrode and a pixel electrode each formed of metal, for example, by utilizing an electrically controlled birefringence (ECB) effect. To be specific, as described in “Monthly Display July” (p. 83 to p. 88, published by Techno Times Co., Ltd., 1997) or “Ekisho vol. 2, No. 4” (p. 303 to p. 316, published by Japanese Liquid Crystal Society, 1998), normally black mode provides completely black display in the absence of an electric field by: adjusting an alignment direction of the liquid crystal cell without application of an electric field, in a direction of an absorption axis of one polarizer; and arranging polarizing plates above and below the liquid crystal cell to be perpendicular to each other. Under application of an electric field, liquid crystal molecules rotate while remaining parallel to substrates, to thereby obtain a transmittance in accordance with a rotation angle. The IPS mode includes super in-plane switching (S-IPS) mode and advanced super in-plane switching (AS-IPS) mode each employing a V-shaped electrode, a zigzag electrode, or the like. Examples of a commercially available liquid crystal display apparatus of IPS mode include: 20-inch wide liquid crystal television “Wooo” (trade name, manufactured by Hitachi, Ltd.); 19-inch liquid crystal display “ProLite E481S-1” (trade name, manufactured by Iiyama Corporation); and 17-inch TFT liquid crystal display “FlexScan L565” (trade name, manufactured by Eizo Nanao Corporation).

In the FFS mode, homogeneously aligned liquid crystal molecules in the absence of an electric field respond in an electric field parallel to substrates (also referred to as a horizontal electric field) generated between a counter electrode and a pixel electrode each formed of transparent conductor, for example, by utilizing an electrically controlled birefringence (ECB) effect. The horizontal electric field in the FFS mode is referred to as a fringe electric field, which can be generated by setting a distance between the counter electrode and the pixel electrode each formed of transparent conductor narrower than a cell gap. To be specific, as described in “Society for Information Display (SID) 2001 Digest” (p. 484 to p. 487) or JP 2002-031812 A, normally black mode provides completely black display in the absence of an electric field by: adjusting an alignment direction of the liquid crystal cell without application of an electric field, in a direction of an absorption axis of one polarizer; and arranging polarizing plates above and below the liquid crystal cell to be perpendicular to each other. Under application of an electric field, liquid crystal molecules rotate while remaining parallel to substrates, to thereby obtain a transmittance in accordance with a rotation angle. The FFS mode includes advanced fringe field switching (A-FFS) mode and ultra fringe field switching (U-FFS) mode each employing a V-shaped electrode, a zigzag electrode, or the like. An example of a commercially available liquid crystal display apparatus of FFS mode includes Tablet PC “M1400” (trade name, manufactured by Motion Computing, Inc.).

The FLC mode utilizes property of ferroelectric chiral smectic liquid crystals encapsulated between electrode substrates each having a thickness of about 1 to 2 μm to exhibit two stable states of molecular alignment, for example. To be specific, the ferroelectric chiral smectic liquid crystal molecules rotate within a plane parallel to the substrates and respond due to application of a voltage. The FLC mode can provide black and white displays based on the same principle as that of the IPS mode or the FFS mode. The FLC mode has such a feature in that a response speed is high compared with those in other drive modes. In the specification of the present invention, the FLC mode includes: surface stabilized ferroelectric liquid crystal (SS-FLC) mode; antiferroelectric liquid crystal (AFLC) mode; polymer stabilized ferroelectric liquid crystal (PS-FLC) mode; and V-shaped switching ferroelectric liquid crystal (V-FLC) mode.

The homogeneously aligned liquid crystal molecules are obtained as a result of interaction between substrates subjected to alignment treatment and liquid crystal molecules, in which alignment vectors of the liquid crystal molecules are parallel to a substrate plane and uniformly aligned. In the specification of the present invention, homogenous alignment includes a case where the alignment vectors are slightly inclined with respect to the substrate plane, that is, a case where the liquid crystal molecules are pretilted. In a case where the liquid crystal molecules are pretilted, a pretilt angle is preferably 20° or less for maintaining a large contrast ratio and obtaining favorable display properties.

Any appropriate nematic liquid crystals may be employed as the nematic liquid crystals depending on the purpose. For example, the nematic liquid crystals may have positive dielectric anisotropy or negative dielectric anisotropy. A specific example of the nematic liquid crystals having positive dielectric anisotropy includes “ZLI-4535” (trade name, available from Merck Ltd., Japan). A specific example of the nematic liquid crystals having negative dielectric anisotropy includes “ZLI-2806” (trade name, available from Merck Ltd., Japan). A difference between an ordinary index (no) and an extraordinary index (ne), that is, a birefringence (Δn_{LC}) can be appropriately selected in accordance with the response speed, transmittance, and the like of the liquid crystals. However, the birefringence is preferably 0.05 to 0.30, in general.

Any appropriate smectic liquid crystals may be employed as the smectic liquid crystals depending on the purpose. The smectic liquid crystals to be used preferably have an asymmetric carbon atom in a part of a molecular structure and exhibit ferroelectric property (also referred to as ferroelectric liquid crystals). Specific examples of the smectic liquid crystals exhibiting ferroelectric property include: p-decyloxybenzylidene-p′-amino-2-methylbutylcinnamate; p-hexyloxybenzylidene-p′-amino-2-chloropropylcinnamate; and 4-o-(2-methyl)butylresorcylidene-4′-octylaniline. Examples of commercially available ferroelectric liquid crystals include: ZLI-5014-000 (trade name, capacitance of 2.88 nF, spontaneous polarization of −2.8 C/cm², available from Merck Ltd., Japan); ZLI-5014-100 (trade name, capacitance of 3.19 nF, spontaneous polarization of −20.0 C/cm², available from Merck Ltd., Japan); and FELIX-008 (trade name, capacitance of 2.26 nF, spontaneous polarization of −9.6 C/cm², available from Hoechst Aktiengesellschaft).

Any appropriate cell gap may be employed as the cell gap (distance between substrates) of the liquid crystal cell depending on the purpose. However, the cell gap is preferably 1.0 to 7.0 μm. A cell gap within the above range can reduce response time and provide favorable display properties.

### J. Liquid Crystal Display Apparatus

The liquid crystal panel of the present invention can be used in a liquid crystal display apparatus such as a personal computer, a liquid crystal television, a mobile telephone, or a personal digital assistant (PDA). Of those, the liquid crystal panel of the present invention is preferably used for a liquid crystal television.

Hereinafter, the present invention will be further described by way of Examples and Comparative Examples. It should be noted that the present invention is not limited to those Examples. Each analysis method used in the Examples is as follows.

### (1) Method of Measuring Thickness:

A thickness was measured using an interference-type thickness meter (“Multichannel photodetector MCPD-2000” (trade name) manufactured by Otsuka Electrical Co., Ltd.). The standard deviation of a thickness measured in an interval of 2 mm and a length of 10 cm in a width direction of a film using the meter was defined as a “variation in thickness”.

### (2) Method of Measuring Retardation Value (Re, Rth):

A retardation value was measured with light having a wavelength of 590 nm at 23° C., using a retardation meter (“KOBRA 21-ADH” (trade name) manufactured by Oji Scientific Instruments) based on a parallel-Nicole rotation method as a principle.

### (3) Method of Measuring Haze Value:

A haze value was measured in accordance with a test method described in JIS K 7136 (2000), using a haze meter (“HM-150” (trade name) manufactured by Murakami Color Research Laboratory).

### (4) Method of Measuring Water Contact Angle:

The contact angle with respect to pure water was measured, using a contact angle meter (CA-X type manufactured by Kyowa Interface Science Co., Ltd.).

### Example 1

### 1. Preparation of an Application Solution

The following were mixed in a mixing ratio described in Table 1 to prepare a liquid crystalline composition: a liquid crystal polymer (weight average molecular weight: 5,000) represented by the following Expression (3); a commercially available liquid crystal compound (“PaliocolorLC242” (trade name) manufactured by BASF) having a phenylbenzoate group as a mesogen group, and having two polymerizable functional groups in a molecular structure; a photopolymerization initiator (“IRGACURE 127” (trade name) manufactured by Ciba Specialty Chemicals Inc.); and a leveling agent (acrylate polymer (butyl acrylate-ethyl acrylate block oligomer with a molar ratio of 50:50, weight average molecular weight: 16,000)). The obtained liquid crystalline composition was mixed with cyclopentanone to be dissolved therein with shaking for 30 minutes at 40° C., whereby an application solution was obtained.

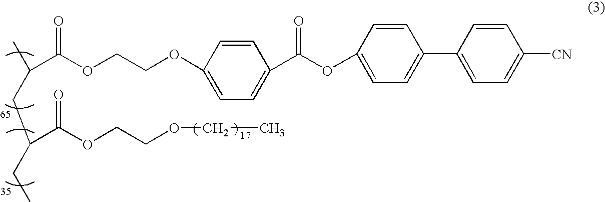

### 2. Preparation of a Laminate

The obtained application solution was applied to a norbornene-based resin film (“ZEONOR (ZF14-100)” (trade name) manufactured by Nippon Zeon, thickness: 100 μm, Re: 120 nm, Nz coefficient: 1.35) satisfying a relationship of nx>ny=nz with a bar coater (“mayer rot HS1.5 #4” (trade name) manufactured by BUSCHMAN). Then, the norbornene-based resin film was dried in an air-circulating thermostatic oven at 80° C. for 3 minutes, whereby a liquid crystalline composition aligned homeotropically was solidified on the norbornene-based film (base material). Then, the solidified layer of the liquid crystalline composition on the base material was irradiated with a UV-ray of 400 mJ/cm² from a side where the application solution was applied while the solidified layer was being transported at a rate of 2.7 cm/min with a UV irradiating machine (“UVC-321AM1” (trade name) manufactured by Ushio Inc.), whereby the solidified layer was further cured. Consequently, a laminate having the base material and a birefringence layer (Re: 0.5 nm, Rth: −100 nm) satisfying a relationship of nz>nx=ny formed on the base material was obtained.

### 3. Evaluation

The obtained laminate was measured for the thickness of a birefringence layer thereof, the variation in thickness, and a haze value. The variation in thickness of 0.007 or less is practically acceptable. Further, the haze value of 0 to 1% is practically acceptable. Table 2 shows the results.

### Comparative Examples 1 to 3

Laminates were obtained in the same way as in Example 1, using application solutions prepared in the mixing ratio described in Table 1. The obtained laminates were measured for the thickness of a birefringence layer thereof, the variation in thickness, and a haze value. Table 2 shows the results.

TABLE 1
Mixing ratio of application solution (parts by weight)

| | | | | Comparative | Comparative | Comparative |
|---|---|---|---|---|---|---|
| | | | Example 1 | Example 1 | Example 2 | Example 3 |
| Solid | Liquid crystal | 1*¹ | 4 | 4 | 4 | 4 |
| content | compound | 2*² | 16 | 16 | 16 | 16 |
| | Photopolymerization | Irgacure | 1 | 1 | 1 | 1 |
| | initiator | 127 | | | | |
| | Leveling agent | Acrylate | 0.3 | — | — | — |
| | | polymer*³ | | | | |
| | | Silicone- | — | — | 0.05 | 0.3 |
| | | based | | | | |
| | | material*⁴ | | | | |

| | | | | | |
|---|---|---|---|---|---|
| Solvent | Cyclopentanone | 79 | 79 | 79 | 79 |

*¹Liquid crsytal polymer represented by Formula (3) (weight average molecular weight: 5,000)
*²“PaliocolorLC242” (trade name) manufactured by BSAF
*³“DISPARON LF1985” (trade name) manufactured by Kusumoto Chemicals Ltd.
*⁴“BYK-370” (trade name) manufactured by BYK Japan KK

TABLE 2

| | | Comparative | Comparative | Comparative |
|---|---|---|---|---|
| | Example 1 | Example 1 | Example 2 | Example 3 |
| Thickness (μm) | 1.1 | 1.1 | 1.1 | 1.1 |
| Variation in | 0.006 | 0.015 | 0.011 | not measured |
| thickness | | | | |
| Haze value (%) | 0.2 | 0.2 | 0.3 | 2.0 |

As shown in Table 2, in the birefringence layer of the laminate in Example 1 using an acrylate polymer as a leveling agent, the variation in thickness (thickness unevenness) was reduced remarkably. In contrast, in Comparative Example 1 not using a leveling agent, the variation in thickness was large, so the laminate in Comparative Example 1 was not practically acceptable. Further, in Comparative Example 2 using about 0.2 parts by weight of a silicone-based leveling agent that was a general leveling agent with respect to 100 parts by weight of a total solid content, the variation in thickness was not reduced sufficiently, so the laminate in Comparative Example 2 was not practically acceptable. In Comparative Example 3 using about 1.5 parts by weight of a silicone-based leveling agent with respect to 100 parts by weight of a total solid content, a haze value was high, and transparency was insufficient, so the laminate in Comparative Example 3 was not practically acceptable. The reason why a haze value increased when the amount of a silicone-based leveling agent used was large is assumed that: a silicone-based leveling agent forms a micro-domain in a birefringence layer.

### Reference Example 1

The one side of the birefringence layer of the laminate obtained in Example 1, which is the opposite side with respect to the side facing the base material, was subjected to a corona treatment under the condition of 116 W/m²·min, using a batch corona treatment apparatus (“CORONA GENERATOR CT-0212” (trade name) manufactured by KASUGA DENKI Co., Ltd). The contact angle of the treated birefringence layer with respect to pure water was 46°, and thus, it was confirmed that the treated birefringence layer has satisfactory wettability. Similarly, when the opposite side with respect to the side facing the base material side of the birefringence layer of the laminate obtained in Comparative Example 2 was subjected to a corona treatment, the contact angle of the birefringence layer with respect to pure water was 57°. The reason why the laminate obtained in Example 1 exhibits satisfactory wettability is considered that a non-silicone-based site (for example, a butyl group of butyl acrylate) of an acrylate polymer forms a coating film of lipophilic groups on an interface of the birefringence layer, and thus, the birefringence layer easily becomes hydrophilic by the corona treatment.

### Example 2

By attaching a polarizing plate (“SIG1423” (trade name) manufactured by Nitto Denko Corporation) via an acrylic pressure-sensitive adhesive (thickness: 20 μm) to the base material side of the laminate obtained in Example 1, a laminate having a polarizer was obtained. At this time, the polarizing plate was attached to the laminate so that an absorption axis of a polarizer of the polarizing plate and a slow axis of a base material that was a positive A plate were perpendicular to each other. Then, a polarizing plate placed on a backlight side of a liquid crystal cell contained in a liquid crystal television (“W37L-H9000” (trade name) manufactured by Hitachi Ltd.) was removed. The above laminate having the polarizer was attached to the liquid crystal cell in place of the removed polarizing plate via an acrylic pressure-sensitive adhesive (thickness: 20 μm) so that the birefringence layer was opposed to the liquid crystal cell, whereby a liquid crystal display apparatus was produced. At this time, the laminate was attached to the liquid crystal cell so that the absorption axis of the polarizer on a viewer side of the liquid crystal cell and the absorption axis of the polarizer of the laminate were perpendicular to each other.

Because the variation in thickness was reduced remarkably in the laminate obtained in Example 1, the adhesion property thereof with respect to a pressure-sensitive adhesive layer was satisfactory. Further, in the liquid crystal display apparatus obtained in Example 2, the roughness of a display in the case where a black display was viewed from an oblique direction was reduced remarkably.

The laminate of the present invention can be preferably used for compensating the birefringence of a liquid crystal layer of liquid crystal cells, in particular, of an IPS mode, an FFS mode, and an FLC mode.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A laminate comprising:
a base material; and
a birefringence layer formed on the base material and satisfying a relationship of nz>nx=ny,
wherein the birefringence layer contains an acrylate polymer.

2. A laminate according to claim 1, wherein the acrylate polymer comprises a copolymer of butyl acrylate and ethyl acrylate.

3. A laminate according to claim 1, wherein a weight average molecular weight of the acrylate polymer is 5,000 to 30,000.

4. A laminate according to claim 1, wherein a content of the acrylate polymer in the birefringence layer is 0.1 to 10 parts by weight with respect to 100 parts by weight of a total of materials forming the birefringence layer.

5. A laminate according to claim 1, wherein a water contact angle of the opposite side of the birefringence layer with respect to the base material is 20° to 55°.

6. A laminate according to claim 1, wherein a haze value of the birefringence layer is 0 to 1.0%.

7. A laminate according to claim 1, wherein the base material contains a thermoplastic resin as a main component.

8. A laminate according to claim 7, wherein the thermoplastic resin comprises a cycloolefin-based resin.

9. A laminate according to claim 1, wherein the base material satisfies a relationship of nx>ny=nz.

10. A laminate according to claim 1, further comprising a polarizer.

11. A laminate according to claim 10, wherein the base material functions as a protective layer of the polarizer.

12. A laminate according to claim 1, wherein the base material is a release film.

13. A liquid crystal panel, comprising:
the laminate according to claim 1; and
a liquid crystal cell.

14. A liquid crystal panel, comprising:
a birefringence layer satisfying a relationship of nz>nx=ny transferred from the laminate according to claim 12; and
a liquid crystal cell.

15. A liquid crystal panel according to claim 13, wherein the liquid crystal cell comprises a liquid crystal layer containing liquid crystal molecules aligned homogeneously in the absence of an electric field.

16. A liquid crystal panel according to claim 14, wherein the liquid crystal cell comprises a liquid crystal layer containing liquid crystal molecules aligned homogeneously in the absence of an electric field.

17. A liquid crystal panel according to claim 15, wherein the liquid crystal cell is one of an IPS mode, an FFS mode, and an FLC mode.

18. A liquid crystal panel according to claim 16, wherein the liquid crystal cell is one of an IPS mode, an FFS mode, and an FLC mode.

19. A liquid crystal display apparatus, comprising the liquid crystal panel according to claim 13.

20. A liquid crystal display apparatus, comprising the liquid crystal panel according to claim 14.
